(19) United States
(12) Patent Application Publication
(10) Pub. No.: US 2026/0269701 A1
(43) Pub. Date: Sep. 10, 2026

(54) MAGNETIC COUPLING ASSEMBLY

(71) Applicant: QUPLING GROUP B.V., Steenwijk (NL)

(72) Inventor: Albert DAHAN, Steenwijk (NL)

(73) Assignee: QUPLING GROUP B.V., Steenwijk (NL)

(21) Appl. No.: 19/489,160

(22) PCT Filed: Jun. 3, 2024
(86) PCT No.: PCT/EP2024/065191

§ 371 Date: Dec. 1, 2025

(30) Foreign Application Priority Data
Jun. 2, 2023 (NL) 2034983

(51) Int. Cl. H02K 49/04

(52) U.S. Cl. CPC H02K 49/046

(57) ABSTRACT

The present disclosure relates to a magnetic coupling assembly for coupling of a first rotary shaft and a second rotary shaft. The magnetic coupling assembly comprises: a first rotary hub connectable to the first shaft; a second rotary hub connectable to the second shaft; a magnet rotor comprising a set of permanent magnets, the magnet rotor coupled to the first rotary hub and arranged to co-rotate with the first rotary hub; and an induction rotor coupled to the second rotary hub and arranged to co-rotate with the second rotary hub, wherein the induction rotor comprises a back plate and at least one induction plate, the back plate and the at least one induction plate being spatially separated.

The present disclosure relates to a magnetic coupling assembly for coupling of a first rotary shaft and a second rotary shaft.

Magnetic couplings are known. A magnetic coupling is a coupling between two shafts that makes use of a magnetic field. One shaft can be coupled to a magnet rotor, while the other shaft can be coupled to an induction rotor. The magnet rotor comprises permanent magnets that are magnetically coupled to the induction rotor. In this way the two shafts can be coupled with a physical separation. The torque of one of the shafts can be effectively transferred to the other shaft. This allows for a coupling that reduces wear.

A problem of existing magnetic couplings is that the temperature of the induction rotor can become relatively high. This high temperature is caused by the current that is created in the induction rotor due to the changing magnetic field. The magnetic field changes due to the slip of the magnet rotor and the induction rotor. This high temperature can cause overheating of the magnetic coupling, which can damage parts of the magnetic coupling, or can even lead to a fire hazard. Due to the characteristic torque curve of a magnetic coupling it is generally not advised to slip a coupling over its peak torque on the torque curve. The torque past its peak torque generally decreases significantly and therefore it is difficult to control the amount of slip which results in large amounts of heat generated in the coupling.

It is an object of the present invention convention to obviate or at least reduce at least one of the above-mentioned problems. In particular, it is an object of the present disclosure to provide a magnetic coupling which could prevent or at least reduce the risk of overheating.

The object is achieved in a magnetic coupling assembly for coupling of a first rotary shaft and a second rotary shaft, the magnetic coupling assembly comprising:
a first rotary hub connectable to the first shaft;
a second rotary hub connectable to the second shaft;
a magnet rotor comprising a set of permanent magnets, the magnet rotor coupled to the first rotary hub and arranged to co-rotate with the first rotary hub; and
an induction rotor coupled to the second rotary hub and arranged to co-rotate with the second rotary hub, wherein the induction rotor comprises a back plate and at least one induction plate, the back plate and the at least one induction plate being spatially separated.

An advantage of the spatial separation between the back plate (herein also referred to as a backing plate) and the at least one induction plate (and, preferably, between neighboring induction plates in embodiments having a plurality of induction plates) is that an internal space through which a fluid (for instance, air) can flow is obtained. In embodiments of the present disclosure the back plate and at least one induction plate are spatially separated to form an air gap located between the back plate and the at least one induction plate.

In the context of the present disclosure, the back plate can be any suitable plate or construction element, or construction part, which is configured to be operatively connected to an induction plate. The back plate can also be denoted as back element, and these terms can be used interchangeably in the present disclosure.

The back plate in the prior art is generally made of magnetic material. In the context of the present disclosure the back plate can also be made of non-magnetic material, such as copper or aluminum.

Due to the rotation of the magnetic coupling assembly ambient air surrounding the magnetic coupling assembly can flow into the internal space(s) (for instance into the air gap) between the back plate and the at least one induction plate. This ambient air has a lower temperature than the back plate and/or the induction plate(s), thereby cooling these plates. The cooling of the fluid flowing through the internal space increases the cooling capacity of the coupling assembly and/or decreases the risk of overheating. This may reduce the risk of malfunctioning of the magnetic coupling assembly which could otherwise occur should individual components of the magnetic coupling assembly become too hot. For instance, malfunctioning may result in the coupling becoming damaged (for instance by melting of certain components) and/or may result in the induction rotors to reduce its ability to transmit torque. Additionally, rotating parts of the coupling may come loose from the coupling assembly and be catapulted to the direct environment which may generate serious safety issues. Furthermore, keeping the temperature of the components of the coupling assembly (especially the components of the induction rotor which basically form the source of heat generation) at a sufficiently low level by the cooling effect increases the lifespan of the magnetic coupling assembly and the installation (drive unit, load) it is installed onto. Alternatively or additionally, it decreases the risk of the magnetic coupling assembly becoming a source of fire.

It is noted that an induction rotor may have a back plate and only one single induction plate. The induction plate then is spatially separated from the back plate. However, in other embodiments, the induction rotor has two (or more) induction rotors. In these embodiments all induction plates may have been arranged at a distance from the back plate (and hence are “spatially separated” from the back plate), but it is also possible that a first induction plate is arranged against the back plate (and therefore is not spatially separated from the back plate) while (at least) a second induction plate is arranged at a distance from the first induction plate and therefore also at a distance from the back plate. The above-mentioned spatial separation between a back plate and at least one induction plate is present in at least one of the induction rotors. In other words, in embodiments with two (or more) induction plates, the magnetic coupling assembly comprises a first induction plate and at least one further induction plate, wherein the first induction plate is arranged against the back plate and the at least one further induction plate is arranged at a distance from the first induction plate. The at least one further induction plate is also arranged at a distance (i.e. an axial distance larger than the axial distance between the first induction plate and the at least one further induction plate).

The magnet rotor may be referred to as central magnet rotor, and these terms may be used interchangeably.

In embodiments of the present disclosure the magnetic coupling assembly comprises a back plate, a first induction plate arranged against the back plate (optionally one (or a stack of) further neighboring induction plate(s) arranged against the first induction plate), a second induction plate arranged at a distance from the first induction plate (or from the closest neighboring further induction plate) to form an air gap between the first induction plate and the second induction plate. In further embodiments one or more additional air gaps are defined between subsequent induction plates arranged at an axials mutual distance from each other.

The back plate and the one or more induction plates are preferably parallelly positioned. Seen in an axial direction, the back plate and the at least one induction plate are preferably positioned in line. The spatial separation between the back plate and the one or more induction plates is preferably provided in the axial direction.

The back plate is preferably made of magnetizable material. The magnetizable material can for example be iron. However, in some embodiments the back plate is made of non-magnetizable material, for instance the same material as the material of the induction plate or different material. The induction plate is preferably made of non-magnetizable material. The non-magnetizable material can for example be copper or aluminum.

In an embodiment the back plate and the at least one induction plate are separated by spacers provided between the back plate and the at least one induction plate.

The spacers may be an cylindrical element that is provided through the back plate and the at least one induction plate. The spacer may comprise rings positioned on the cylindrical element and positioned between the back plate and the at least one induction plate, such that the rings separate the back plate and the at least one induction plate.

In an embodiment the magnetic coupling assembly comprises at least two induction plates, each induction plate being spatially separated from each other. Using at least two induction plates further improves the magnetic (contactless) coupling between the magnet rotor and the induction rotor. Alternatively or additionally, the induction plates provide a further cooling effect, as the combined cooling surface is increased (doubled or even more). In embodiments of the present disclosure between each adjacent induction plates a spacer element like a cylindrical element, for instance a ring, may be provided to ensure a suitable interspace between the plates.

Combining two or more different forms of the induction plates positioned parallel to each other allows for (varying of) a torque curve with different characteristics. For example when combining a solid induction plate with a slotted induction plate results in a torque curve with a peak torque at a different slip speed than with just one form of induction plate. Also two or more slotted induction plates but each with a different number of slots or differently shaped slot forms results in different torque curves.

The above also is applicable to an assembly with a segmented induction plate.

In an embodiment the back plate comprises iron and the induction plate comprises copper or aluminum.

The back plate is preferably made of magnetizable material. The magnetizable material can for example be iron. The induction plate is preferably made of conductive non-magnetizable material. The conductive non-magnetizable material can for example be copper or aluminum. The mentioned materials provide an effective magnetic coupling assembly.

In an embodiment a distance between the back plate and the induction plate is in the range of 1-20 mm, preferably 2-15 mm, even more preferably in the range of 2-5 mm, for instance about 3 mm.

Experiments have shown that the abovementioned ranges provide an optimal balance between a compact design and sufficient cooling of the induction rotor.

In an embodiment the magnetic coupling assembly comprises a main rotor that is coupled to the secondary rotary hub, wherein the induction rotor is coupled to the main rotor. While the inductor rotor is at least partially made of magnetizable material, the main rotor preferably is made of essentially non-magnetizable material. This may make it easier and/or safer to manufacture (in particular, to assemble) the magnetic coupling assembly. For instance, the main rotor may form an essentially non-magnetizable base or support at which the induction rotor may be safely mounted and aligned (balanced), without or with a reduced strength of magnetic forces that would otherwise be generated due to the presence of the magnet rotor in close proximity to the main rotor.

In an embodiment the magnetic coupling assembly comprises a main rotor that is coupled to the secondary rotary hub, wherein the induction rotor is coupled to the main rotor and wherein the induction rotor comprises a plurality of induction rotor segments, each of the induction rotor segments being coupled to the main rotor via a segment coupling.

The magnetic force of the magnet rotor forces the induction rotor to co-rotate, thereby providing a coupling between the first and second rotary shaft. The induction rotor is configured to co-rotate with the magnet rotor.

An advantage of the induction of rotor segments is that the induction rotor can be assembled in parts. The attraction between an induction rotor segment and the magnet rotor is smaller than between the induction rotor as a whole and the magnet rotor. Therefore, the induction rotor segments provide a safer assembling of the magnetic coupling. This decreases the risk of hazardous situations for the workers assembling the magnetic coupling. Furthermore, since balancing of the rotor(s) of the coupling assembly becomes easier and extensive balancing can be dispensed with, the total costs of the coupling assembly may be reduced. Furthermore, less precise machining of the components of the induction rotor is required.

Another advantage is that with the induction rotor segments it is easier to construct a uniform weight distribution of the induction rotor. When induction rotor segments are provided that are identical in weight, the weight distribution of the induction rotor is more uniform when the rotor segments are assembled. This provides easy assembling of the induction rotor at a smaller cost.

A further advantage is that due to a segment coupling according to embodiments of the present disclosure the induction rotor segments can be more safely coupled to the main rotor (or the main rotor/hub in case the main rotor and hub are formed by the same element) and therefore to a shaft with a reduced safety risk for the worker actually assembling the coupling.

In an embodiment the segment coupling comprises a guide and an insertion element. Preferably, the guide and the insertion element extend in a radial direction of the rotors and/or induction rotor segments. The insertion element preferably is an elongated element that fits into an elongated guide. This way, the induction rotor segments can approach the main rotor in a radial direction.

As the magnetic field of the magnet rotor is small in a radially outward direction in case the magnets are arranged inside the magnet rotor, the magnetic attraction force between the induction rotor segments and the magnet rotor is minimal. Therefore, the induction rotor segments can be safely attached to the main rotor, for instance before moving the magnetizable material into the strong magnetic field, without the danger of injury to the hands of the workers.

When the attraction of the induction rotor segments and the magnet rotor increases by moving the induction rotor segments in the radial direction towards the center, the guide and the insertion element are already locked into each other and prevent movement of the induction rotor segments in the axial direction. This increases the safety of assembly of the magnetic coupling assembly and the danger of injury to the hands of the workers is reduced. Also the likelihood of possible damage to the coupling parts is reduced or eliminated because the risk of collision between the induction segment and the magnet rotor is ruled out due to the limited movement of the induction segments relative to the magnet rotor.

In an embodiment the guide is provided at the main rotor and the insertion element is provided at the induction rotor segment, while in another embodiment the guide is provided at the main rotor and the insertion element is provided at the main rotor.

By providing the guide on the main rotor insertion element on the induction rotor segments an effective coupling between the main rotor and the induction rotor segments is realized.

In an embodiment the guide and the element are complementary shaped, preferably T-shaped, trapezoidal or the like.

By the guide and the insertion element being complementary shaped, it is ensured that after assembly the guide and the insertion element will not detach from each other. Preferably, the guide and the insertion elements are T-shaped. The head of the T-shaped guide is positioned away from the magnet rotor such that the head can counter any attraction from the induction rotor to the magnet rotor. Preferably, the guides comprise an inner space which is T-shaped.

In an embodiment the plurality of induction rotor segment comprises an even number of induction rotor segments.

An even number of induction rotor segments may provide the advantage of arranging induction rotor segments radially opposite of each other, although the use of an odd number of induction rotor segments is also possible. Furthermore, the mass of the individual rotor segments is selected to be such that in assembled condition the center of mass of the combination of induction rotor segments is located at the position of the associated shaft. In case the induction rotor segments have the same shape, the mass of each of the segments is selected to be the same. The configuration and distribution of the induction rotor segments provides a stable configuration and an effective balanced weight distribution of the induction rotor.

The uniform mass distribution around the center of the shaft prevents any unwanted forces on the shaft during rotation of the induction rotor. This decreases the wear and increases the lifespan of the magnetic coupling and the machinery it is installed onto.

In an embodiment the plurality of induction rotor segments are arranged as pairs of induction rotor segments each comprising a first and second induction rotor segment that are spatially separated by a spacer, wherein the first induction rotor segment is positioned on a first side of the magnet rotor and is coupled to the main rotor via the segment coupling, and the second induction rotor segment is positioned on a second and opposite side of the magnet rotor.

The first induction rotor segments comprise a first set that is coupled to the main rotor. The second induction rotor segments comprise a second set that is positioned on the opposite side of the magnet rotor relative to the main rotor as seen in an axial direction. The first and second induction rotor segments are preferably plate-shaped extending in the radial direction.

One induction rotor segment of the first set and one induction rotor segment from the second set form a pair of induction rotor segments.

An advantage of the induction rotor segments being arranged as pairs of induction rotor segments, is that the rotor segments can be positioned over the magnet the rotor in a symmetric way as seen in an axial direction. Due to the induction rotor segments being positioned at both sides of the magnet rotor when approaching the magnet rotor radially, any magnetic attraction to the first of the induction rotor segments is countered by the attraction to the second induction rotor segment of the pair of induction rotor segments. This decreases the chance of undesired axial magnetic attraction of the magnet rotor and the induction rotor during assembly, thereby increasing the safety for the workers. In embodiments of the present disclosure induction rotor segments of a first set of induction rotor segments are coupled to the main rotor via the segment coupling, and a second set of induction rotor segments are coupled to a connection ring. Although the connection ring is optional, it may increase the sturdiness of the construction and may help to keep the individual segments properly positioned thereby reducing the risk of deformation of the induction rotor assembly.

In other embodiments of the present disclosure induction rotor segments of a first set of induction rotor segments are coupled to a first main rotor via the segment coupling, and/or the induction rotor segments of a second set of induction rotor segments are coupled to a second main rotor via a segment coupling. In still further embodiments the induction rotor segments of a first set of induction rotor segments are coupled to a first main rotor via the segment coupling, and a second set of induction rotor segments are arranged next to a second main rotor without them being coupled to the second main rotor via a segment coupling.

One induction rotor segment of the first set and one induction rotor segment from the second set form a pair of induction rotor segments.

The first set of induction rotor segments are positioned adjacently and form a first induction rotor. The first set is coupled to the (first) main rotor with the segment coupling. The second set of induction rotor segments are positioned adjacently and form a second induction rotor. The second set of induction rotor segments may be coupled to a connection ring (or to a second main rotor/further rotor). In one possible embodiment, the connection ring couples the second set of induction rotor segments to each other. Due to the connecting ring any radial movement of the second induction rotor segments is prevented. This provides a robust magnetic coupling assembly. In another possible embodiment a set of (adjustable) spacers couples the second set of induction rotor segments to each other.

In an embodiment each induction rotor segment comprises a back plate and at least one induction plate, wherein the induction plate faces the magnet rotor.

The back plate is preferably made of magnetizable material. The magnetizable material can for example be iron. The induction plate is preferably made of non-magnetizable material. The non-magnetizable material can for example be copper or aluminum.

In an embodiment the spacer comprises a female part comprising an inner thread and a male part comprising an outer thread, wherein the distance between the first and second induction rotor segment is adjustable by threadingly moving, for instance screwing, the male part into the female part or vice versa.

Due to the threaded connection between the male part and the female part the distance between the first set of induction rotor segments and the second set of induction rotor segments can be adjusted in an easy manner. Adjustment of the distance between the two rotor segments sets can be advantageous in case the amount of torque that is transferred between the shafts needs to be changed.

The spacer may comprise a first threaded part (for instance a first threaded end part) for engaging in a first opening (for instance in a first rotor/segment/plate) and a second threaded part for engaging in a second opening (for instance a second rotor/segment/plate), wherein the first threaded part and second threaded part are oppositely threaded. For instance, the spacer may comprise external threaded end parts that are configured to engage in openings with internal threading so to allow the axial distance between the first rotor/segment/plate and the second first rotor/segment/plate to be adjusted by simply rotating the spacer in an appropriate direction. In an embodiment the spacers are provided with grooves to improve airflow and thereby improve the cooling capabilities of the coupling.

The grooves create a draft which sucks surrounding fluid into the space between the induction rotor segments. This surrounding fluid, for example air, which is sucked into the space can cool the induction rotor segments and the magnet rotor which is provided between the induction rotor segments.

In an embodiment the back plate is a plate-shaped element operatively connected to the induction plate or a construction part operatively connected to the induction plate.

Further advantages, features and details are elucidated on the basis of exemplifying embodiments thereof, wherein reference is made to the accompanying drawings, wherein:

FIG. 1 shows a side view of a first embodiment of a magnetic coupling assembly arranged between examples of a drive unit and a load unit;

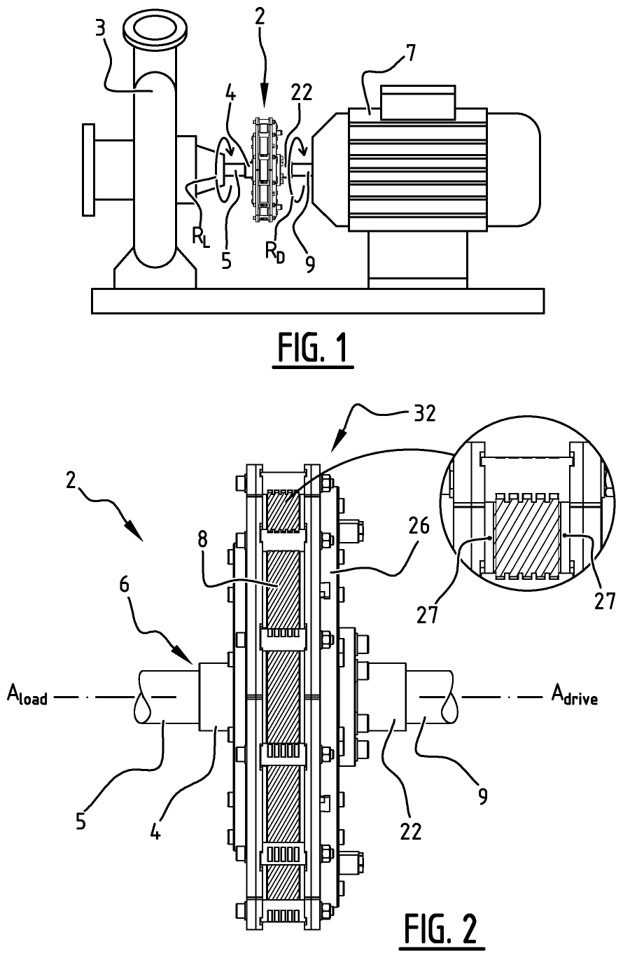

FIG. 2 shows a side view of the first embodiment of the magnetic coupling assembly;

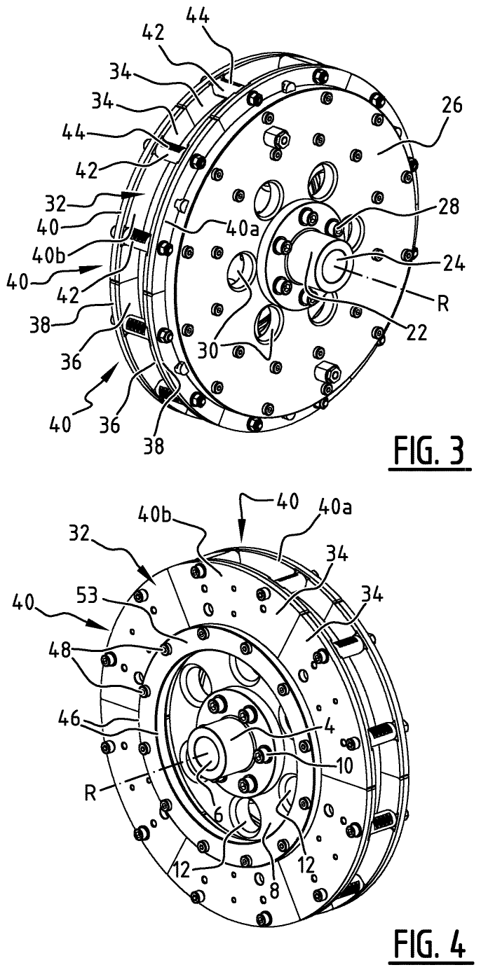

FIGS. 3 and 4 show perspective views of the first embodiment of the magnetic coupling assembly;

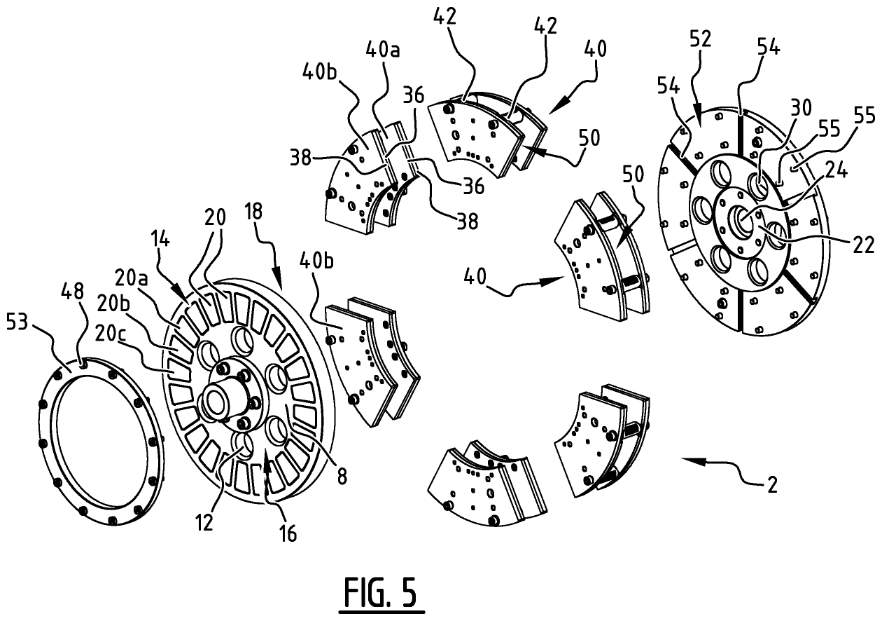

FIG. 5 shows an exploded view of the first embodiment of the magnetic coupling assembly;

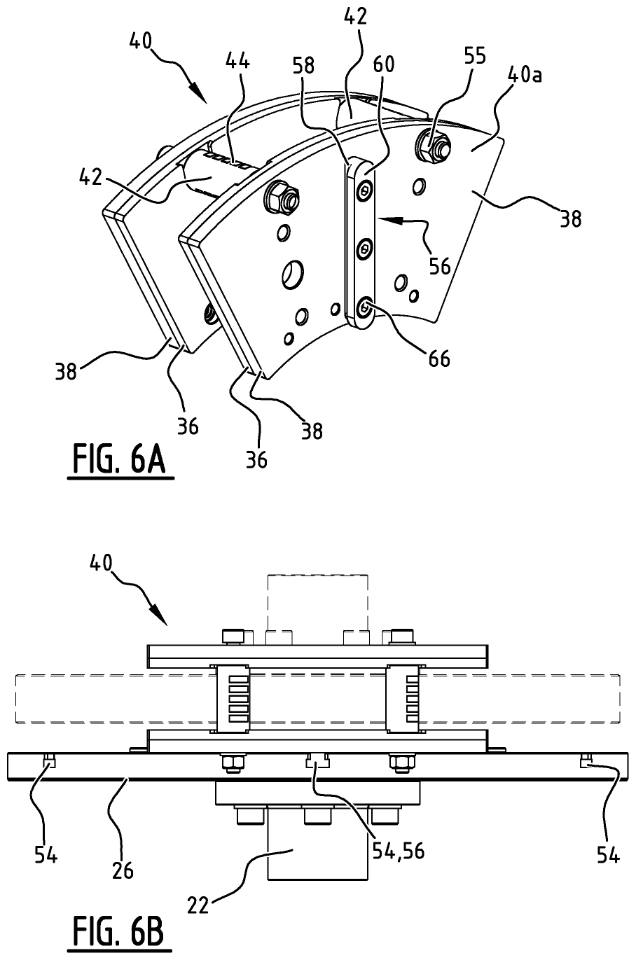

FIGS. 6A and 6B show respectively a perspective side view and a top view of a pair of induction rotor segments forming a rotor segment;

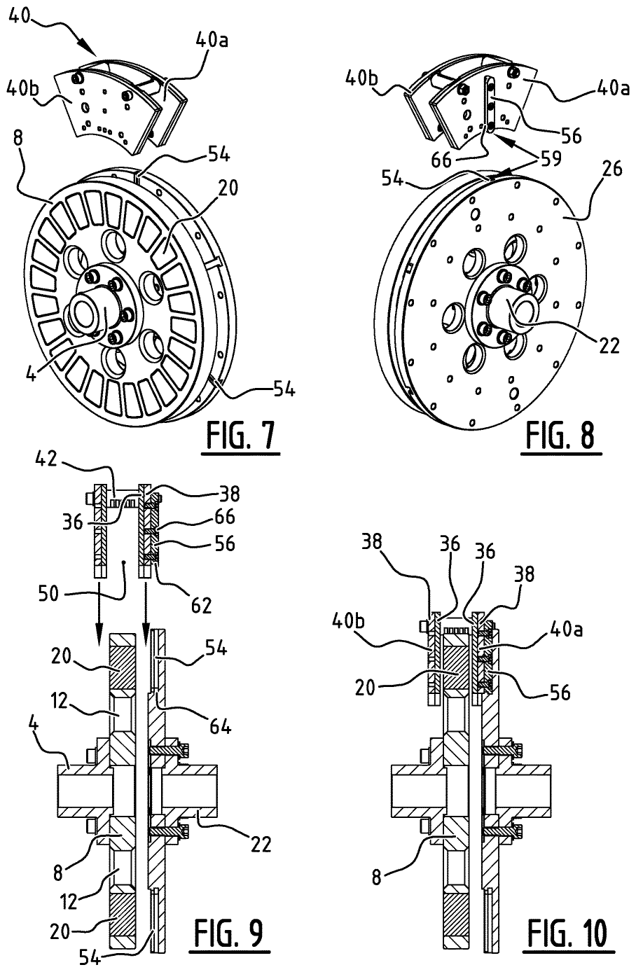

FIGS. 7-10 show perspective and side views of the assembly of the magnetic coupling assembly;

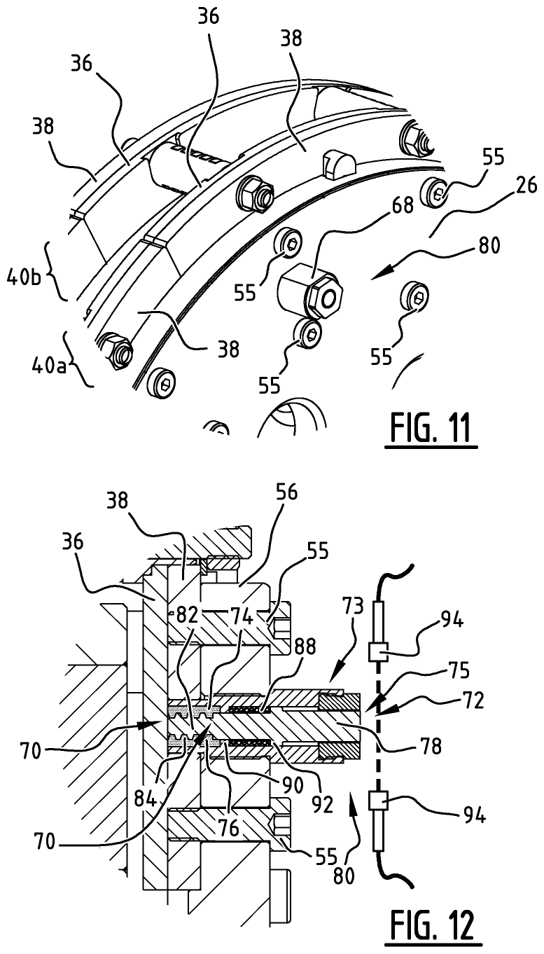

FIG. 11 shows a perspective view of the temperature detection unit in the normal state;

FIG. 12 shows a side view of the temperature detection unit in the normal state;

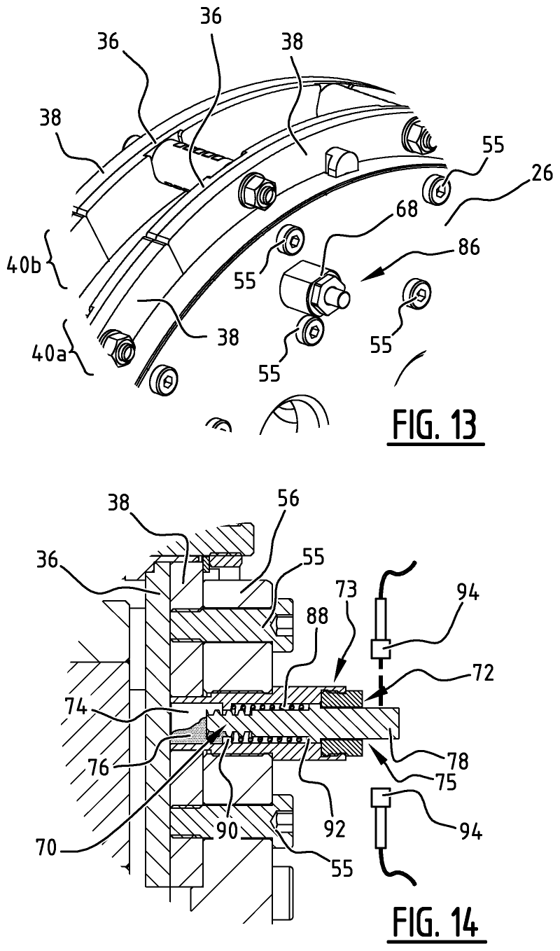

FIG. 13 shows a perspective view of the temperature detection unit in the extended state;

FIG. 14 shows a side view of the temperature detection unit in the extended state;

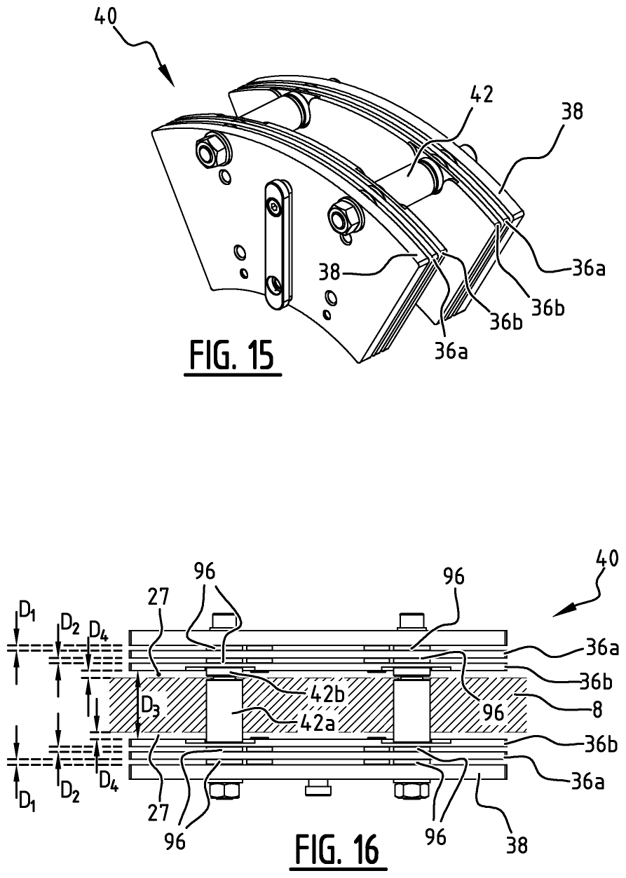

FIG. 15 shows a perspective view of a pair of induction rotor segments;

FIG. 16 shows a top view of a pair of induction rotor segments according to a further embodiment;

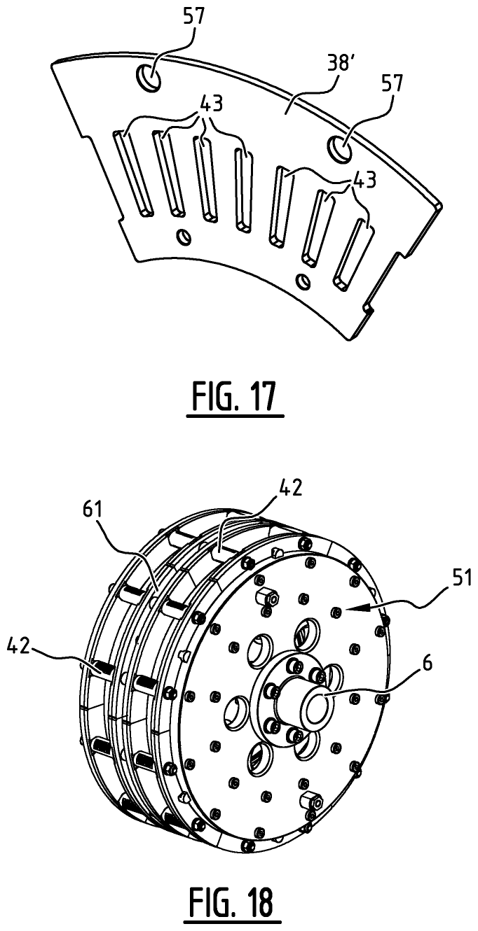

FIG. 17 is a side view of a further embodiment of an induction plate of an induction rotor segment part of an inductor rotor;

FIG. 18 is a side view of a further embodiment of a magnetic coupling assembly;

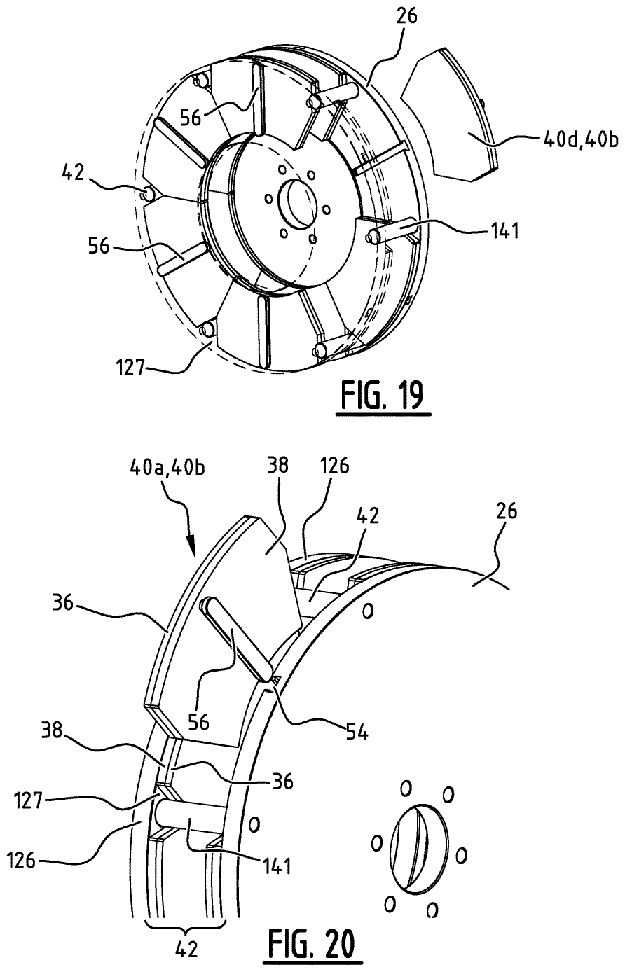

FIG. 19 is a partly cut-away side view of a further embodiment of a magnetic coupling assembly having two parallel main rotors;

FIG. 20 is a more detailed side view of the embodiment of FIG. 19, just before an inductor segment is attached to a main rotor;

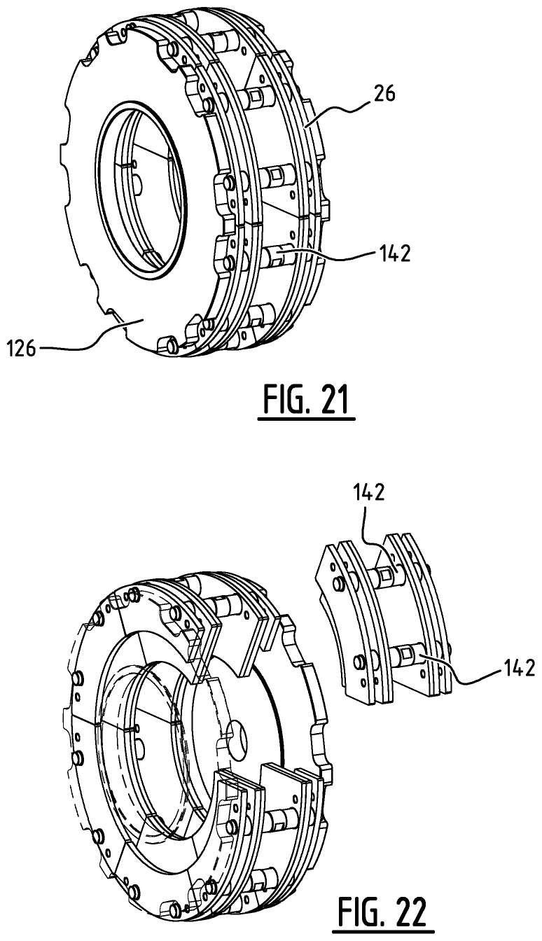

FIG. 21 is a side view of a further embodiment of a magnetic coupling assembly showing two main rotors between which a plurality of segments has been mounted wherein the spacers are configured to have an adjustable length;

FIG. 22 is a partly cut-away view of the embodiment of FIG. 21, showing one pair of induction rotor segment parts right before attachment to the main rotor(s) by sliding action;

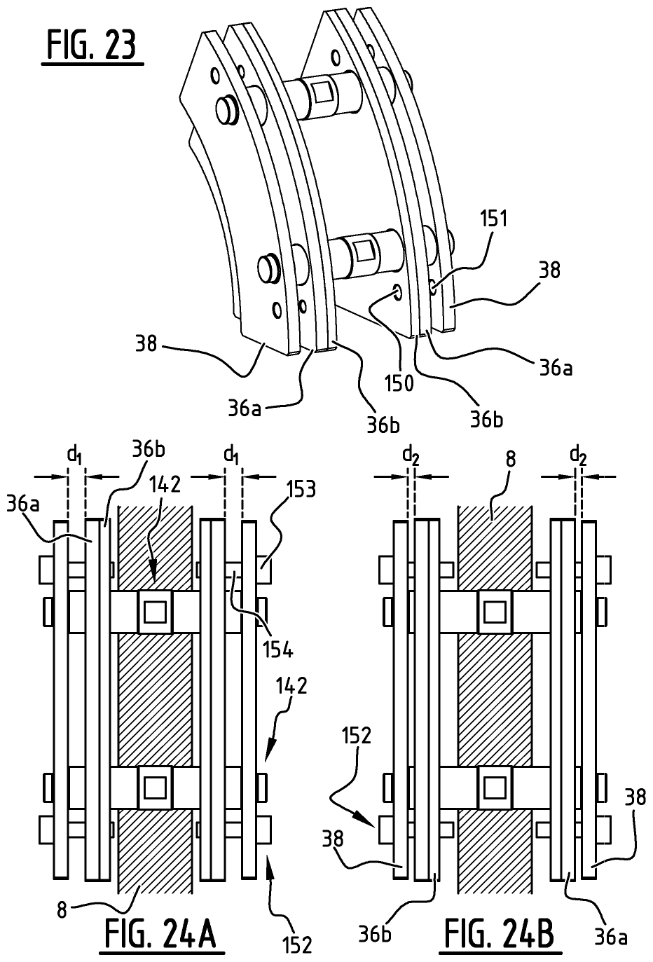

FIG. 23 is a side view of an embodiment of the pair of induction rotor segment parts of FIG. 22;

FIGS. 24A and 24B are cross-sections of the pair of induction rotor segment parts, respectively in a first position wherein the mutual distance between a back plate and a set of induction plates is relatively large and a second a position wherein the mutual distance between a back plate and a set of induction plates is relatively small;

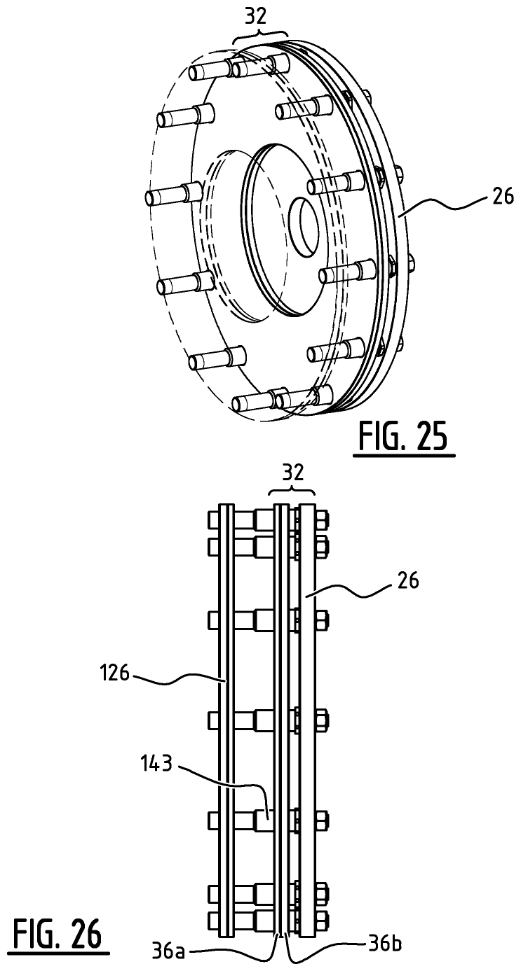

FIG. 25 is a partly cut-away side view of a further embodiment of the magnetic coupling assembly, having adjustable spacers and an induction rotor at one side only (single arrangement);

FIG. 26 is a side view of the embodiment of FIG. 25;

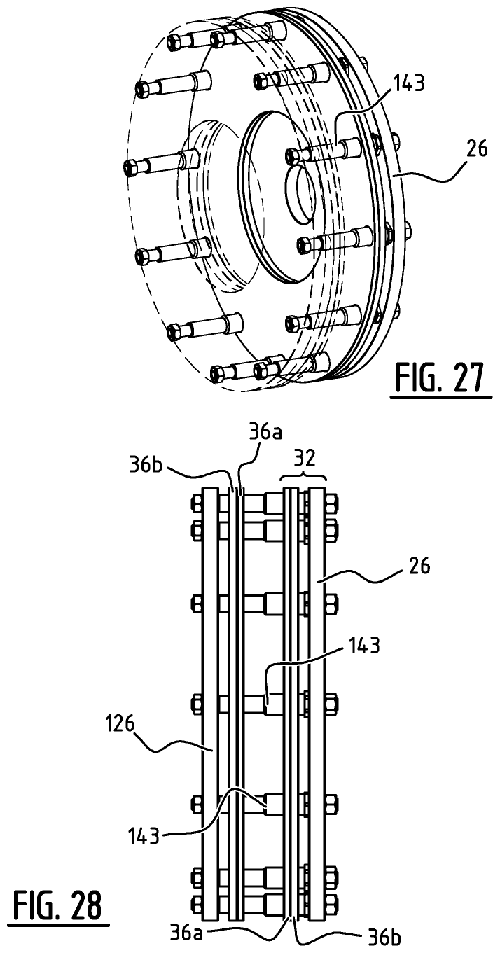

FIG. 27 is a partly cut-away side view of a further embodiment of the magnetic coupling assembly, having adjustable spacers and an induction rotor at both sides of the magnet rotor; and

FIG. 28 is a side view of the embodiment of FIG. 27.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Furthermore, the terms first, second, third and the like in the description and in the claims, are used for distinguishing between similar elements and not necessarily for describing a sequential or chronological order. The terms are interchangeable under appropriate circumstances and the embodiments of the disclosure can operate in other sequences than described or illustrated herein. Moreover, the terms top, bottom, over, under and the like in the description and the claims are used for descriptive purposes and not necessarily for describing relative positions. The terms so used are interchangeable under appropriate circumstances and the embodiments of the disclosure described herein can operate in other orientations than described or illustrated herein.

As will be apparent to those of skill in the art upon reading this disclosure, each of the individual embodiments described and illustrated herein has discrete components and features which may be readily separated from or combined with the features of any of the other several embodiments without departing from the scope of the present invention. Any recited method can be carried out in the order of events recited or in any other order which is logically possible.

Referring to FIGS. 1-6, a first exemplifying embodiment of a magnetic coupling assembly 2 arranged between a drive unit 7 and a load unit 3 is shown. The drive unit 7 may be any type of drive or drive motor, like an electric motor or a combustion engine, capable of causing a drive shaft 9 (herein also referred to as the second shaft) to rotate (denoted by R_{D}). The load unit 3 may be any type of load that is to rotatable driven by the drive unit 7. The load may be any type of machine like a fan, turbine, pump etc. having a load shaft 5 (herein also referred to as the first shaft) that is to be rotated (R_{L}) by drive shaft 9 of the drive unit 7.

The magnetic coupling assembly 2 comprises a least one (possibly two or more) first, generally disc-shaped, rotary element, herein referred to as a magnet rotor 8 (see the hatched part in FIG. 2), a second, for instance a generally disc-shaped element, herein referred to as a main rotor 26, a first rotary hub 4 mounted to (for instance using bolts 10) or integrally formed with the magnet rotor 8 and a second rotary hub 22 mounted to (for instance using bolts 28) or integrally formed with the main rotor 26. The first rotary hub 4 is configured to be releasably connected to the first (load) shaft 5 of the load unit 3 and second rotary hub 22 is configured to be releasably connected to the second (drive) shaft 9 of the drive unit 7. The first rotary hub 4 and the magnet rotor 8 belong to the load side of the magnetic coupling assembly 2 while the second rotary hub 22 and the main rotor 26 belong to the drive side of the magnetic coupling assembly.

In the embodiments described hereafter the main rotor 26 may have coupled thereto a separate induction rotor 32. However, in all of the embodiments described hereafter the combination of such mutually coupled inductor rotor 32 and main rotor 26 can also be embodied as an integrated rotor (i.e. the induction rotor and main rotor being combined into one single (induction) rotor.

In embodiments of the present disclosure the second (main) rotor 26 and the second rotary hub 22 (or first rotary hub 4) may be separate elements, while in other embodiments the second (main) rotor 26 and the secondary hub 22 are integrated and form a single integrated rotor-hub element. For instance, the rotary hub may be formed as a rotor.

The magnetic coupling assembly 2 is configured to cause the first (load) shaft 5 to co-rotate with the second (drive) shaft 9 using a magnetic type of coupling between the (inductor rotor coupled to the) main rotor 26 and magnet rotor 8. In principle no physical contact is present between the drive side and the load side of the magnetic coupling assembly 2. In other words, any torque provided by the drive unit 7 is transferred from the drive shaft to the load shaft using a magnetic field rather than a physical mechanical connection.

While the first hub 4 and second hub 9 are arranged to be mutually aligned, the magnetic coupling assembly 2 can be said to be rotatable relative to a common imaginary axis R (cf. FIGS. 3 and 4). Furthermore, the rotation speed (i.e. the number of revolutions per unit of time) of the second (drive) shaft 9 may be the same as the rotation speed of the first (load) shaft 5 or may differ. Generally the rotation speed of the second (drive) shaft 9 is higher than the rotation speed of the first (load) shaft 5, according to a constant or adjustable speed ratio.

In order to connect the rotary hubs 4, 22 to the respective shafts 5, 9 the first rotary hub 4 may comprise a cylindrical opening 6 (FIG. 4) configured to receive therein an end of the first shaft 5 while the second rotary hub 22 may comprise a cylindrical opening 24 (FIG. 3) configured to receive therein an end of the second shaft 9.

Both the magnet rotor 8 and the main rotor 26 are optionally provided with cooling means, for instance one or more air openings 12 (for instance, six air openings) in the magnet rotor 8 and one or more air openings 30 in the main rotor 26. The air openings 20, 30 may be positioned at predefined radial distances relative to the imaginary rotation axis R. Other distributions of the air openings 20, 30 are possible as well. Furthermore, in the illustrated embodiments, openings 12 of magnet rotor 8 and openings 30 of main rotor 26 are provided at an equal distance to imaginary rotation axis R, such that openings 12 and openings 30 are positioned substantially in line when viewed in axial direction. The axial direction is in the illustrated embodiments parallel to the imaginary rotation axis R.

An inductor rotor 32 may be integrally formed with or mounted to the main rotor 26. In other embodiments, an inductor rotor 32 is removably coupled to the main rotor 26. Furthermore, the induction rotor 32 may be formed by one or more annular induction elements wherein at least one of the annular induction elements is attached (removably or permanently) to the main rotor 26. In other embodiments, for instance in the illustrated embodiments, the induction rotor 32 is comprised of multiple induction rotor segments 34. In the embodiments shown in FIGS. 1-10 and 15-16, the induction rotor 32 comprises a plurality of induction rotor segments, each induction rotor segment 34 being shaped as an annulus sector defined as an imaginary cut from an annulus, which is bordered by two straight lines from the center of the annulus (i.e. from the center corresponding to the location of the imaginary rotation axis R). In the shown embodiment the inductor rotor segments 34 are of equal shape and dimension (so that their fabrication may be standardized, which may reduce the overall costs of the inductor rotor 32). Furthermore, the inductor rotor segments 34 may be coupled one by one to the main rotor 26 (cf. FIGS. 7-10) to form the induction rotor 32. This has a number of advantages in the sense of ease of fabrication, less precise machining of the individual components of the induction rotor, simplified balancing of the rotor(s) of the coupling assembly, and/or reduction of the total manufacturing and assembly costs. A further advantage may be the possibility to reduce particular types of hazard generally associated with the fabrication of magnetic couplings, as will be explained in connection with FIGS. 7-10.

In the shown embodiments the number of induction rotor segments 34 is six. In other embodiments the shape and dimension may mutually vary and/or the number of segments may be larger or smaller.

In embodiments of the present disclosure, for instance in the embodiments shown in FIGS. 5-10, each induction rotor segment 34 comprises a back plate 38 made of magnetizable material, for instance iron, while attached to the back plate 38 is a front (induction) plate or simply an induction plate 36, preferably made of a non-magnetizable material, for instance copper. In some embodiments, for instance in the embodiment of FIGS. 15 and 16, an induction rotor segment 34 comprises a plurality of induction plates 36 (i.e. induction plates 36a, 36b, cf. FIG. 15-16), as will be explained later.

In embodiments of the present disclosure the inductor rotor 32 is located at one side of the magnetic coupling assembly (i.e. a so-called single inductor coupling), i.e. at one side of the magnet rotor 8, either at the side of the drive unit 7 or at the side of the load unit 3. However, in other embodiments the inductor rotor 32 is present at both sides. Furthermore, while in the embodiments shown in FIGS. 1-10, the inductor rotor 32 is present at both sides of a single magnet rotor (a so-called dual inductor coupling), in other embodiments, for instance in the embodiment of a magnetic coupling assembly 51 of FIG. 18 (a so-called quad inductor coupling), two magnet rotors are provided and an inductor rotor 32 is present at both sides of each of the magnet rotors. The number of magnet rotors may even be larger than two and embodiments with a plurality of magnet rotors with each magnet rotor only having an associated inductor rotor present at one single side thereof are possible as well.

Furthermore, as shown in the figures, the inductor rotor 32 may be comprised of a number of induction rotor segments 34 wherein each induction rotor segments 34 comprises a pair 40 of induction rotor segment parts 40a, 40b, interconnected by one or more spacers 42.

Each pair 40 of induction rotor segment parts comprises a first induction rotor segment part 40a and a second induction rotor segment part 40b. A first induction rotor segment part 40a and a second induction rotor segment part 40b of a pair 40 are, seen in a direction parallel to the imaginary rotation axis R, attached to each other such that they remain spaced apart by use of one or more elongated spacers 42. The first induction rotor segment parts 40a are attached in such a manner to the second induction rotor segment parts 40b that induction plates 36 of the induction rotor segment parts 40a, 40b are positioned to face each other. Additionally, the second induction rotor segment parts 40b may be attached to each other by a connecting ring 53. The optional connecting ring 53 may be attached near inner edge 46 of each of the induction rotor segment parts 40b, for instance using bolts 48 or similar fastening means. Furthermore, the first induction rotor segment parts 40a are attached to main rotor 26 by respective segment couplings 59.

Spacers 42 are provided with slits 44. Slits 44 are configured to increase the air flow in between induction rotor segments 40. Further details about the spacers including a description of a specific embodiment thereof will be presented in connection with FIG. 16.

FIG. 5 shows an exploded view of magnetic coupling assembly 2. Shown from left to right are the connecting ring 53, magnet rotor 8, pairs 40 of induction segment parts 40a, 40b, and the main rotor 26. The connecting ring 53 has a generally annular shape (defining an open space in its center allowing passage of the first rotary hub 4 and/or the first shaft 5 connected to the first rotary hub 4). As mentioned above, connecting ring 53 is provided with bolts 48. The bolts are inserted into induction segment parts 40b so as to bolt each of the induction rotor segment parts 40b onto the connecting ring 53. The bolts 48 may be distributed at an equal distance around connecting ring 53.

Referring to FIG. 5, magnet rotor 8 is provided with a plurality of through holes 14 configured for accommodating a plurality of permanent magnets. In other embodiments, not shown in the figures, the holes are blind holes (forming a pocket as it were wherein a magnet may be accommodated). Holes 14 extend from first side 16 to second side 18 of magnet rotor 8. In each through hole 14 an associated permanent magnet 20 is arranged. Through holes 14 and permanent magnet 20 are in the illustrated embodiment trapezium shaped, other shapes are possible as well. Preferably, the adjacent permanent magnets 20 are arranged so that their respective magnetic poles are provided in an alternating manner. As an example, seen on first side 16, permanent magnet 20a has at first side 16 its north pole, adjacent permanent magnet 20b has at first side 16 its south pole, and permanent magnet 20c, which is positioned adjacent to permanent magnet 20b, has at first side 16 its north pole.

Each pair 40 of induction rotor segment part 40a, 40b comprises at least one (preferably two) spacers 42. Each induction rotor segment part 40a, 40b comprises a back plate 38 and at least one induction plate 36. Front plates 36 of induction rotor segment parts 40a, 40b are facing each other. In between induction plates 36 an inner space 50 is provided. The mutual distance between the induction plates 36 of facing induction rotor segments parts 40a, 40b is slightly larger than the local thickness of the magnet rotor 8 so that at both sides of the magnet rotor 8 a small air gap 27 (cf. FIG. 2) remains and the magnet rotor 8 may freely rotate between the induction segment parts 40a, 40b.

Referring to FIGS. 5-11, the induction rotor 32 is coupled to the main rotor 26 by removably coupling the first induction rotor segment parts 40a to main rotor 26 by respective segment couplings 59. More specifically, each of the segment couplings 59 comprises an elongated connecting element 56 extending in a generally radial direction and mounted to back plate 38 of induction rotor segment 40a using a number of fasteners 66, for instance bolts, wherein the connecting element 56 is configured to be slidingly received in an associated recess 54, herein also referred to as a slit, provided in a connection surface 52 provided on one side of the main rotor 26. Slits 54 generally extend in a radial direction, i.e. a radial direction corresponding to the radial direction of the connecting element 56. Induction rotor segment parts 40a can be removably coupled to the main rotor 26 by sliding the connecting element 56 in a radially directing inward (arrows in FIG. 9) into and along the radial slits 54. In the shown embodiment the radial slits 54 are substantially T-shaped in cross-section. Other shapes are possible as well. Connecting element 56 is substantially T-shaped in cross-section as well, with a projection 58 extending from back plate 38 and head 60 positioned at the end of projection 58. Head 60 extends in a direction perpendicular to the radial direction and axial direction, and parallel to the surface of back plate 38. Since connecting element 56 is capable of being moved into and out of slit 54 (even if one or more neighboring induction rotor segments 34 have already been put into place) and since connecting element 56 and slit 54 are complementary shaped, the pair 40 of induction rotor segment parts 40a, 40b can be easily and firmly coupled to the main rotor 26 by an inward sliding action or can be easily removed from the main rotor 26 (for instance for maintenance or repair purposes) by an outward sliding action.

The number of radial slits 54 may correspond to the number of induction rotor segments 34 (in the shown embodiments the number is six) if each induction rotor segment 34 is coupled to the main rotor by using one single segment coupling. However, in other embodiments the number of segment couplings 59 for each induction rotor segment 34 may be larger (or smaller if the induction rotor segments 34 are mutually coupled as well).

More specifically, FIGS. 7-10 show a preferred method of assembling the magnetic coupling assembly 2. In the illustrated embodiment first rotary hub 4 and second rotary hub 22 are already attached to first shaft 5 and second shaft 9 respectively (both first shaft 5 and second shaft 9 are not shown). Main rotor 26 is already attached to second rotary hub 22 and thus faces magnet rotor 8. Pair of induction rotor segments 40 can now be positioned over magnet rotor 8. Pair 40 of induction rotor segment parts 40a, 40b is positioned radially outwards of main rotor 26. Connecting element 56 that is provided on induction rotor segment 40a is aligned with slit 54 of main rotor 26. Connecting element 56 is attached to induction rotor segment 40a with bolts 66 that extend into back plate 38. The pair of induction rotor segments 40a, 40b is moved in a radial direction towards the center of the assembly (i.e. towards the imaginary rotation axis R), such that connecting element 56 slides into slit 54. Head 60 of connecting element 56 is locked in the corresponding head shape of slit 54. In this way pair of induction rotor segments 40 are firmly attached to main rotor 26 and at the same time effectively aligned. Inner edge 62 of connecting element 56 abuts inner end 64 of slit 56. Permanent magnets 20 are then positioned in inner space 50 between induction plates 36. Inductor plates 36 are also positioned equidistant from permanent magnets 20 of magnet rotor 8.

FIGS. 19-22 show further embodiments of the present invention. While the magnetic coupling assembly may comprise at least one combination of a (first) main rotor 26 and a connecting ring 53 (as is shown, for instance, in FIG. 4), in these further embodiments the magnetic coupling assembly comprises one (in fact, at least one) combination of a first main rotor 26 and a second main rotor 126. As is shown in FIGS. 19 and 20, both the first main rotor 26 and the second main rotor 126 may have been provided by radial slits 54. The slits 54 in the first main rotor 26 are located at similar positions in the second main rotor 126 so that each pair 40 of induction rotor segment parts 40a, 40b can be moved in a radial direction towards the center of the assembly, such that connecting elements 56 provided at both sides of each pair 40 of induction rotor segments 40a, 40b may slide into the respective slits 54 so as to firmly attach them to the first and second main rotors 26, 126. An advantage of the present embodiments is that one can assemble some kind of protective cage (formed by the two main rotors arranged at both sides of the potentially dangerous magnet rotor) using essentially non-magnetic material (without a risk of body parts (fingers) of an individual to get stuck between magnetic parts and the magnets of the magnet rotor). Only once the protective cage has been arranged around the magnet rotor, the inductor segments parts are moved into place. Since the inductor segments parts are moved in place one-by-one the magnetic forces pulling on the inductor segments parts can be kept relatively small thereby further reducing the risk of injuries. While in the embodiment of FIGS. 19 and 20 the spacers 141 have been attached to the first main rotor 26 and the second main rotor 126 so as to keep both rotors at a suitable mutual axial distance, in the embodiment of FIGS. 21 and 22 the spacers 142 have been attached to the main rotors (i.e. the first and second main rotors) (while the induction segment parts 40a, 40b may move freely in axial direction over the spacers, as will be explained later) so as to keep both rotors at a suitable mutual axial distance (similar to the spacers 42 in the embodiments of FIG. 2-13). In the embodiment of FIGS. 19 and 20 the induction segment parts 40a, 40b have cut-away corners 127 to allow the induction segments part 40a, 40b to be attached to the main rotor(s) while still providing space for the spacers 141 to be attached to the main rotors 26, 126.

The assembly order in the embodiments of FIGS. 2-13 may be: placing the (potentially dangerous) magnet rotor on the first hub (often at the load side, sometimes at the drive side), placing the (essentially non-magnetic) main rotor 26 at a first side of the magnet rotor, attaching the pairs 40 of induction rotor segments (interconnected by spacers 42) one-by-one to the main rotor (keeping the magnet rotor in between the two induction rotor segment parts 40a, 40b, preferably right in the middle between the induction rotor segment parts) (wherein the attachment comprises sliding/pivoting/hinging or swiveling action for arranging the segments parts in a suitable end position and then fastening the segment parts to the main rotor in the end position by using fasteners 55, FIG. 13), and then (optionally) connecting the connection ring 53.

The assembly order in the embodiments of FIGS. 21, 22 may become: placing the magnet rotor 8, placing the first main rotor 26 at a first side of the magnet rotor, placing the second main rotor 126 at a second, opposite side relative to the magnet rotor 8, and placing the pairs 40 of induction rotor segments (interconnected by spacers 142) one-by-one between the first and second main rotors (keeping the magnet rotor in between the two induction rotor segment parts 40a, 40b, preferably right in the middle between the induction rotor segment parts). In the embodiment of FIGS. 19 and 20 wherein the spacers 141 are to be attached directly to the first and second main rotors 26, 126 (and not to the induction rotor segments) the assembly order may become: placing the magnet rotor, placing the first main rotor at a first side of the magnet rotor, placing the second main rotor at a second, opposite side relative to the magnet rotor, attaching the spacers 141 one-by-one between the first and second main plates 26, 126, and then consecutively attaching the induction rotor segment 40a or 40 one-by-one to respectively the first and second main rotor 26, 126.

While in the above-described embodiments the induction rotor segments are attached by a sliding action in an inward radial direction, in other embodiments an induction rotor segment is attached to a main rotor by a pivoting (swiveling or hinging) action. For instance, an inductor rotor segment 40a, 40b may be attached to a main rotor 26, 126 by a hinge, whereas the inductor rotor segment can be tilted from the outer position towards the final position of the segment onto the main rotor.

Referring to FIGS. 11-14, a temperature indication unit 68 (in specific embodiments an overheating detection unit or a fail-safe unit) is shown. The temperature indication unit 68 is a unit configured to provide a warning signal (i.e. a visual signal, an acoustic signal or, preferably, an electronic signal if use is made of a contactless sensor, as will be explained later) in case of imminent overheating of the induction rotor 32 of the magnetic coupling assembly. Overheating is a general issue with magnetic couplings and may lead to malfunctioning of the coupling or even to dangerous situations for the immediate environment of the coupling: due to the large rotation speeds of the rotors of the coupling and/or the relatively large mass of the rotating components thereof, break-down of the coupling is to be avoided at all times. In case the temperature detection unit 68 generates an electronic warning signal, the drive unit 7 may be controlled to reduce its rotational speed or may even be controlled to stop rotating allowing the coupling to cool down.

FIGS. 11 and 12 show a particular embodiment of a temperature detection unit 68 in its normal (operational) state, while FIGS. 13 and 14 show the same embodiment wherein the temperature detection unit is in its warning (operational) state.

The temperature indication unit 68 comprises a housing 73 mounted to at least one of the main rotor 26 and inductor rotor 32. Housing 73 has a first end 70 and a second end 72 (cf. FIGS. 12, 14). Housing 73 is made of thermally conductive material to allow heat generated in the induction rotor 32 (more specifically in the induction and back plates thereof) and/or in the main rotor 26 to be transferred to the interior of the housing. In FIG. 12 it is shown that the end of the housing not only contacts the main rotor 26 but also extends through the main rotor 26 and the back plate 38 to contact the induction plate 36. In other embodiments the housing 73 only contacts the main rotor 26, only extends through the main rotor 26 to contact the back plate, or extends through the main rotor 26, the back plate 38 and at least partially through the induction plate 36.

The interior of the housing defines a cylindrical (or differently shaped) interior into which a sensing element 78, for instance a pin or similar elongated element may be arranged. In general, the sensing element may be configured to be axially movable in the housing (outwardly or inwardly), but in other embodiments the sensing element is configured to be radially movable or movable in an oblique direction (with both an axial and a radial component). In still further embodiments the sensing element is rotatably attached to at least one of the main rotor(s) and induction rotor(s) so that an end of the sensing element is movable in a circumferential direction (herein also referred to as the rotational direction) to generate the warning signal.

In the shown embodiment, the sensing element 78 is arranged in the interior of the housing via opening 75 and is configured to be movable in axial direction (i.e. in a direction parallel to the direction of the imaginary rotation axis R) inwardly or outwardly (towards or away from the main rotor 26, respectively).

Near first end 70 the interior of the housing defines a chamber 74 is arranged. The part of the housing 73 at the end first end 70 of the chamber 74 (or, in other embodiments wherein the housing is open at its first end 7, the retainer material 76 inside the chamber 74) is partly in contact with induction plate 36 of induction rotor segment 40a (or 40b). Due to being in contact with induction plate 36 (or, in other embodiments, to the back plate 38 and/or the main rotor 26), a rise in temperature in the induction rotor (especially in the induction plate 36 thereof) will cause a rise in temperature inside chamber 74. In chamber 74 thermally conductive and meltable material 76 is provided. Material 76 is selected to have a melting point that substantially coincides with or has a fixed relation to a preselected temperature, for instance a critical temperature like a maximum desired temperature of induction rotor 32.

FIGS. 11 and 12 show the earlier-mentioned sensing element 78 of the temperature detection unit 68 in its normal (operational) state. In the normal state securing end 82 of sensing element 78 (i.e. the end closest to the source of heat, that is closest to the induction plate 36) is firmly secured inside the housing 73 due to the fact that it is surrounded by the material 76 that is in a solid (not yet melted) state. To increase the grip of the material 76 onto (securing end 82 of) the sensing element 78 one or more circumferential flanges or ridges 84 are provided. Due to the one or more ridges 84 sensing element 78 has a higher resistance to material 76 and therefore material 76 grips sensing element 78 more tightly. In normal state sensing element 78 is positioned substantially completely inside housing 73. Further provided in the interior of housing 73 is resilient element 88, in this embodiment shown as a spring, for instance a coil spring. Resilient element 88 is configured to bias sensing element 78 towards opening 75 of housing 73 at outer end 72. The biasing is achieved by resilient element 88 resting on top wall 90 of chamber 74 and abutting and pressing against an abutment part 92 of sensing element 78. For instance, the abutment part may be formed by a circumferential protrusion or, in the shown embodiment, a circumferential thickening of the sensing element 78.

Temperature detection unit 68 is in FIGS. 13 and 14 shown in warning state 86. Due to a temperature increase in the induction rotor 32 the temperature of the retainer material 76 inside the chamber 74 is raised. Eventually the temperature in chamber 74 reaches a level wherein the material 76 starts to melt. Once the material 76 has been sufficiently melted (or at least caused to become softer), the grip of the material 76 on the sensing element 78 is reduced so that the biasing force of the resilient element 88 finally becomes larger than the gripping force of the material 76 so that the sensing element 78 is forced to move outwardly so that the outer end of the sensor element 38 is moved out of the housing. FIGS. 13 and 14 show the state wherein the sensing element 78 has been moved outwardly over distance sufficient to generate a warning signal. This warning signal could be a visual warning signal since the sensing element 78 in the warning state 86 is projecting out of the housing which will be visible by the operator of the magnetic coupling assembly. The operator may take appropriate action, for instance reducing the speed of the drive unit shaft or even completely bringing the coupling assembly to a standstill. In other embodiments the movement of the sensing element from the normal state to the warning state will trigger an external sensor (i.e. a stationary sensor positioned remotely from the rotating parts of the magnetic coupling assembly), which external sensor then generates an electronic warning signal, as will be explained hereafter.

The retainer material 76 could be any material that is capable of retaining the sensing element 78 in place against the biasing force (i.e. a pulling force or a pushing force) of the resilient member 88 when the temperature in the chamber 74 is below a critical (melting temperature), while becoming soft enough to allow the sensing element 78 to be moved outwardly (ejected) once the temperature exceeds the critical temperature. The critical temperature may be defined as the maximum temperature at which the coupling assembly may function safely. Examples of this material are tin, zinc, or similar materials like fusible alloys which have a specific composition of to achieve an exact melting point with a high liquid fluidity. These fusible alloys often have a low melting temperature.

As mentioned above, in the embodiment shown in the figures, in warning state 86 sensing element 78 has been moved outwardly so as to partially extend outside the second end 72 of housing 73. In other embodiments, the sensing element 78 is caused to move in the opposite direction, i.e. inwardly when going from the normal state to the warning state. In the latter embodiments the fact that a sensing element has been moved to the warning state can be detected visually (for instance by an operator) to generate a visual warning only or can be sensed by an external sensor to generate an electronic signal. The following description of the operation of the external sensor in case of a sensing element moving outwardly can be similarly applied to a sensor element moving inwardly, radially, obliquely or in a rotational direction.

In some embodiments of the present disclosure the movement of the sensing element 78 from the normal state to the warning state is accomplished by the centrifugal forces (g-forces) exerted onto the sensing element when the rotors of the coupling assembly are rotating. This may for instance be the case in embodiments wherein the sensor element is arranged to be movable in the radial direction or at least in a direction that has a radial component. Once retainer material 76 is melted to the extent that the sensing element 78 can no longer be retained in the housing, the centrifugal forces urge the sensing element to move to the warning state.

In other embodiments the movement of the sensor element 78 needs to be generated by a biasing element. An example of a biasing element may be a resilient member 88. The biasing element (resilient member) may be configured to bias the sensing element in an outward direction or in an inward direction. In the following an embodiment is described wherein the biasing element is configured to urge the sensing element in an outward direction once the sensing element can no longer be retained by the retainer material 76. However, it will be appreciated that the biasing element could similarly be arranged to urge the sensing element in an inward direction once the sensing element can no longer be retained by retainer material 76. It may even be possible to configure the biasing element (resilient member) to cause a rotatably mounted sensing element to move the sensing element to the warning state once the sensing element can no longer be retained.

In a further embodiment the magnet coupling assembly comprises a plurality of temperature detection units 68 wherein each of the temperature detection units is configured to have a different preselected temperature. For instance, in a first temperature detection unit 68 the preselected temperature is a relatively low first critical temperature while in a second first temperature detection unit 68 the preselected temperature is a relatively high second critical temperature while. When the induction rotor is heated the first, relatively low temperature is reached first causing the controller to take first measures like reducing the rotation speed of the drive shaft 9 of the drive unit 7 or only generating an audible and/or visible warning signal, while when the temperature still increases and reaches the second, higher temperature, the controller completely shuts down the drive unit 7.

As shown in FIGS. 11-14, resilient element rests on ceiling 90 of chamber 74 and abuts abutment part 92 of sensing element 78. Resilient element 88 is able to move sensing element 78 due to the melting of material 76. Due to sensing element 78 extending out of second and 72 of housing 73, proximity sensor 94 measures that 78 extends out of housing 73. Based on the detection of proximity sensor 94 an electronic warning signal is generated. This signal may be received via a wireless or wired connected by an electronic controller configured to control at least the drive unit 7. Based on the received warning signal the controller may control the drive unit 7 to lower the rotation speed of the second shaft (driving shaft) 9. Alternatively or additionally, the controller may control a warning signal generator like a loudspeaker or a lamp to generate an audible and/or visible warning signal.

Each of induction rotor segment parts 40a, 40b (FIGS. 15 and 16) comprises in this embodiment a back plate 38, while each back plate 38 is provided with a plurality of associated induction plates 36a, 36b rather than only one single back plate 38 as in earlier described embodiments. Backplate 38 and first induction plate 36a are separated by axial distance D1. First induction plate 36a and second induction plate 36b are separated by axial distance D2. The axial distances between plate 38 and induction plates 36a and 36b are achieved by rings 96 that are provided in between the plates 36a, 36b, 28. The interspace provided between plates 38, 36a, 36b increases the airflow when the plates are rotating, thereby reducing the temperature of the plates 38, 36a 36b, in particular of induction plates 36a, 36b.

The spacers 42 may have a constant length in order to ensure a constant distance between the segments 40a, 40b. However, according to other embodiments, the length of the spacers 42 (defining the axial distance between opposing second induction plates 36b or between opposing induction plates 36 in embodiments wherein the length-adjustable spacer is applied to the earlier-described embodiments of FIGS. 1-14) may be adjustable. For instance, in the embodiment shown in FIGS. 15 and 16, the spacer comprises a female spacer part 42a and a male spacer part 42b. Male spacer part 42b comprises an outer thread and female spacer part 42a comprises an inner thread. Distance D₃ between induction plates 36b can be adjusted by relative rotation of male spacer part 42b and female spacer part 42a.

While in the exemplifying embodiments described thus far the inductor plate 36 of an induction rotor segment part 40a, 40b is an essentially solid plate, FIG. 17 shows another embodiment wherein the inductor plate 36′ of the inductor rotor 32 has one or more slots 43 (the number of slots shown is seven, but this number could be larger or smaller). Such slotted inductor plate 36′ has the advantage that the pate may be additionally cooled by the relatively cool ambient air that is caused to flow along the exposed parts (i.e. the regions where the slots 43 are located) when the magnetic coupling assembly is rotating. Alternatively or additionally, the one or more slots 43 in one or more of the inductor plates makes it possible to vary the torque curve (transmission characteristic) of the coupling assembly. Referring to the embodiment shown in FIGS. 20-23, 24A, 24B, the spacers 142 are attached with their opposing ends to a first backplate 38 at one side and a second backplate 38 at a second, opposite side. The induction plates 36a, 36b can move freely over the outer surface of the spacers 142 (by forming openings in the induction plates 36a, 36b with a diameter slightly larger dan the diameter of the spacers 142) so that their mutual axial distance (d) can be varied by sliding the induction plates back and forth. For instance, FIGS. 24A and 24B show the result of this operation. In FIG. 24A the mutual distance d₁ between a back plate 38 and the first induction plate 36a is relatively large, while FIG. 24B shows a situation wherein the mutual distance d₂ between a back plate 38 and the first induction plate 36a is relatively small. The mutual distance is set by means of a set of secondary spacers 152. The secondary spacers 152 may be comprise of an elongated element 154 provided with external screw thread and a head 153. The secondary spacer 152 that may be screwed into the openings 150 in the induction plates 36a, 36b and back plate 38 thereby adjusting the gap between them (so as to fix the plates at a suitable mutual distance). The axial position of the magnet rotor can remain unchanged during this operation.

In many of the embodiments described herein there is induction material arranged at both sides of the magnet rotor 8 (see, for instance, the embodiments of FIGS. 1-13, 18-24B. See also FIGS. 27 and 28 showing a first main rotor 26, a second main rotor 126, and first induction rotor 32 next to the first main rotor 26 and a second induction rotor 32 next to the second main rotor 126), i.e. induction material (rotor segment parts) at one side and induction material (rotor segment parts) at the other side (seen in axial direction) of the magnet rotor 8. However, in further embodiments, induction material may be arranged at one side only of the magnet rotor 8 (for instance in light-weight application wherein the torque exerted on the load/driving shafts are restricted). Such embodiment is shown in FIGS. 25 and 26. The figures show an embodiment wherein the magnetic coupling assembly comprises a first main rotor 26, a second main rotor 126, and a single induction rotor 32. More specifically, the magnetic coupling assembly has the following arrangement (from right to left): main rotor provided with spacers—inductor set/rotor—magnet rotor (not shown)—inductor set/rotor. The induction rotor may be formed by one single induction plate or by various induction plate segments, as described herein.

In several embodiments described herein the spacers 42, 142 have a fixed length. However, in other embodiments the spacers may have an adjustable length. For instance, the spacers 143 may be of a telescopic type wherein their length can be manually made larger or smaller by having an operator rotate the spacers in a suitable direction (when the rotors of the magnetic coupling assembly are stationary). In still other embodiments the spacers have a fixed length but still enable adjustment of the axial distance between rotors of the magnetic coupling assembly. This is for instance the case in the embodiment shown in FIGS. 25 and 26 and in the embodiment of FIGS. 27 and 28. A spacer 43 may be configured to adjust the axial distance between two elements that are spaced apart by the spacer (for instance a first and second inductor rotor or induction rotor segment) by arranging the threaded parts (for instance threaded end parts comprised of external threading, one part being provided with left-hand thread and the other, opposite part being provided with right-hand thread) ) in threaded openings (i.e. the openings being provided with internal threading) into which the external threading provided on the spacer engages so that (manually) turning the spacer causes the two elements to be moved in axially direction towards or away from each other to reduce resp. increase their mutual distance. In still other embodiments the gap between the rotors can be adjusted using the above-mentioned secondary spacers 152.

Further aspects and embodiments of the present disclosure are defined in the following clauses.

### Clause 1

Magnetic coupling assembly for coupling of a first rotary shaft and a second rotary shaft, the magnetic coupling assembly comprising:
a first rotary hub connectable to the first shaft;
a second rotary hub connectable to the second shaft;
a magnet rotor comprising a set of permanent magnets, the magnet rotor coupled to the first rotary hub and arranged to co-rotate with the first rotary hub;
a main rotor coupled to the second rotary hub and arranged to co-rotate with the second rotary hub; and
an induction rotor coupled to the main rotor, wherein the induction rotor comprises a plurality of induction rotor segments, each of the induction rotor segments coupled to the main rotor via a segment coupling.

### Clause 2

Magnetic coupling assembly as defined in clause 1, wherein the segment coupling is configured to allow an induction rotor segment to be coupled to the main rotor by a sliding movement in a radial inward direction.

### Clause 3

Magnetic coupling assembly as defined in clause 1 or 2, wherein the segment coupling comprises a guide, for instance a recess or slit, and an insertion element, for instance an elongated connecting element, configured to be received in the guide.

### Clause 4

Magnetic coupling assembly according to clause 3, wherein the guide is provided at or in the main rotor and the insertion element is provided at the induction rotor segment.

### Clause 5

Magnetic coupling assembly as defined in any of the clauses 3-4, wherein the guide is provided at or in the induction rotor segment and the insertion element is provided on the main rotor.

### Clause 6

Magnetic coupling assembly according to any of clauses 3-5, wherein the guide and the insertion element are shaped to extend in a generally radial direction.

### Clause 7

Magnetic coupling assembly as defined in any of clauses 3-6, wherein the guide and the insertion element are complementary shaped, preferably T-shaped or trapezoidal.

### Clause 8

Magnetic coupling assembly as defined in any of the preceding clauses, wherein the induction rotor segment is connected to the main rotor by a hinge, configured to allow the induction rotor segment to be tilted from an outer position towards a final position of the induction rotor segment onto the main rotor.

### Clause 9

Magnetic coupling assembly according to any of the foregoing clauses, wherein the plurality of induction rotor segments are arranged as pairs of induction rotor segments each comprising a first and second induction rotor segment that are spatially separated by a spacer, wherein the first induction rotor segment is positioned on a first side of the magnet rotor and is coupled to the main rotor via the segment coupling, and the second induction rotor segment is positioned on a second and opposite side of the magnet rotor.

### Clause 10

Magnetic coupling assembly according to clause 9, wherein a first set of induction rotor segments are coupled to the main rotor via the segment coupling, and a second set of induction rotor segments are coupled to a connection ring.

### Clause 11

Magnetic coupling assembly according to any of the preceding clauses, comprising a first main rotor and a second main rotor, wherein the first main rotor and second main rotor are interconnected by one or more spacers, wherein optionally the spacers are configured to have an adjustable length.

### Clause 12

Magnetic coupling assembly according to any of the preceding clauses, comprising a first main rotor and a second main rotor, wherein induction rotor segments of a first set of induction rotor segments are coupled to the first main rotor via the segment coupling and/or the induction rotor segments of a second set of induction rotor segments are coupled to the second main rotor.

### Clause 13

Magnetic coupling assembly according to any one of the preceding clauses, wherein the spacer comprises a female part comprising an inner thread and a male part comprising an outer thread, wherein the distance between the first and second induction rotor segment is adjustable by threadingly moving the male part into the female part.

### Clause 14

Magnetic coupling assembly according to any one of the preceding clauses, wherein the spacers are provided with grooves to improve airflow.

### Clause 15

Magnetic coupling assembly according to any one of the foregoing clauses, wherein the induction rotor comprises a back plate and at least one induction plate, wherein the back plate preferably comprises iron and the induction plate comprises copper or aluminum.

### Clause 16

Magnetic coupling assembly according to any one of the foregoing clauses, wherein the main rotor and induction rotor are combined to form one integrated rotor and/or wherein the main rotor and the secondary rotary hub are combined to form an integrated rotor-hub element.

### Clause 17

Magnetic coupling assembly according to any one of the foregoing clauses, comprising a further magnet rotor arranged parallel to the magnet rotor and comprising a further induction rotor arranged to co-rotate with the second rotary hub as well.

### Clause 18

Magnetic coupling assembly according to any of the foregoing clauses, wherein the magnet rotor is a central magnet rotor.

### Clause 19

Method for assembling a magnetic coupling assembly as defined in any of the preceding clauses, the method comprising:
providing a magnet rotor;
arranging the main rotor beside the magnet rotor;
couple a single induction rotor segment to the main rotor;
repeating the coupling of a single induction rotor segment to the main rotor for all induction rotor segments.

### Clause 20

Method as defined in clause 19, comprising mutually connecting induction rotor segments by attaching a connecting ring or a second main rotor.

### Clause 21

Method as defined in clause 19 or 20, wherein coupling the induction rotor segments to the main rotor comprises one-by-one sliding or pivoting an induction rotor segment into a coupled position, for instance one-by-one sliding an induction rotor segment in radial direction into the coupled position.

### Clause 22

Method as defined in clause 19, 20 or 21, wherein the magnetic coupling assembly have pairs of induction rotor segments, the method comprising sliding or rotating a pair of induction rotor segments over the magnet rotor such that the first induction rotor segment moves along the first side of the magnet rotor and the second induction rotor segment moves along the second side of the magnet rotor.

The present invention is by no means limited to the above-described exemplifying embodiments thereof. The rights sought are defined by the following claims within the scope of which many modifications can be envisaged.

1. A magnetic coupling assembly for coupling of a first rotary shaft and a second rotary shaft, the magnetic coupling assembly comprising:
a first rotary hub connectable to the first shaft;
a second rotary hub connectable to the second shaft;
a magnet rotor comprising a set of permanent magnets, the magnet rotor coupled to the first rotary hub and arranged to co-rotate with the first rotary hub; and
an induction rotor coupled to the second rotary hub and arranged to co-rotate with the second rotary hub, wherein the induction rotor comprises a back plate and at least one induction plate, the back plate and the at least one induction plate being spatially separated.

2. The magnetic coupling assembly according to claim 1, wherein the back plate and at least one induction plate are spatially separated to form an air gap located between the back plate and the at least one induction plate.

3. The magnetic coupling assembly according to claim 2, wherein the induction rotor comprises a back plate and an induction plate arranged at a distance from the back plate to form an air gap between the back plate and the induction plate.

4. The magnetic coupling assembly according to claim 2, wherein the induction rotor comprises a back plate, a first induction plate arranged against the back plate and a second induction plate arranged at a distance from the first induction plate to form an air gap between the first induction plate and the second induction plate.

5. The magnetic coupling assembly according to claim 1, comprising at least two induction plates, each induction plate being spatially separated from each other.

6. The magnetic coupling assembly according to claim 1, wherein back plate comprises magnetic material, such as iron, and the induction plate comprises copper or aluminum.

7. The magnetic coupling assembly according to claim 1, wherein the back plate comprises a non-magnetic material, such as copper or aluminum.

8. The magnetic coupling assembly according to claim 1, wherein a distance between the back plate and the induction plate is in the range of 1-20 mm, preferably 2-15 mm, even more preferably in the range of 2-5 mm, for instance about 3 mm.

9. The magnetic coupling assembly according to claim 1, wherein an induction plate is a slotted induction plate comprising one or more slots.

10. The magnetic coupling assembly according to claim 1, further comprising:
a main rotor coupled to the second rotary hub and arranged to co-rotate with the second rotary hub; and
an induction rotor coupled to the main rotor, wherein the induction rotor comprises a plurality of induction rotor segments, each of the induction rotor segments coupled to the main rotor via a segment coupling.

11. The magnetic coupling assembly according to claim 1, wherein the plurality of induction rotor segments are arranged as pairs of induction rotor segments each comprising a first and second induction rotor segment that are spatially separated by a spacer, wherein the first induction rotor segment is positioned on a first side of the magnet rotor and is coupled to the main rotor via the segment coupling, and the second induction rotor segment is positioned on a second and opposite side of the magnet rotor.

12. The magnetic coupling assembly according to claim 1, wherein the back plate and the at least one induction plate are separated by first spacers provided between the back plate and the at least one induction plate.

13. The magnetic coupling assembly according to claim 1, comprising a first main rotor and a second main rotor, wherein the first main rotor and second main rotor are interconnected by one or more second spacers.

14. The magnetic coupling assembly according to claim 12, wherein the first and/or second spacers are configured to have an adjustable length.

15. The magnetic coupling assembly according to claim 12, wherein the first and/or second spacers comprises a female part comprising an inner thread and a male part comprising an outer thread, wherein the distance between the first and second induction rotor segment is adjustable by threadingly moving the male part into the female part.

16. The magnetic coupling assembly according to claim 1, wherein a first and/or second spacer is of fixed length and/or comprises a first threaded part for engaging in a first opening and a second threaded part for engaging in a second opening, wherein the first threaded part and second threaded part are oppositely threaded.

17. The magnetic coupling assembly according to claim 12, wherein the first and/or second spacers are provided with grooves to improve airflow.

18. The magnetic coupling assembly according to claim 1, wherein the main rotor and induction rotor are combined to form one integrated rotor and/or wherein the main rotor and the secondary rotary hub are combined to form an integrated rotor-hub element.

19. The magnetic coupling assembly according to claim 1, wherein the induction rotor comprises a back plate, a first induction plate arranged at a distance from the back plate and a second induction plate arranged at a distance from the first induction plate to form an air gap between the back plate and the first induction plate and between the first induction plate and the second induction plate.

20. The magnetic coupling assembly according to claim 1, wherein the induction rotor comprises a back plate, a first induction plate and a second induction plate, wherein the first induction plate and the second induction plate are arranged against each other, and wherein the first and second induction plates are spatially separated or arranged at a distance from the back plate.

21. The magnetic coupling assembly according to claim 1, wherein the first induction plate and the second induction plate are of different material, preferably one induction plate being made of copper and one induction plate being made of aluminum.

22. The magnetic coupling assembly according to claim 1, wherein the magnet rotor is a central magnet rotor.

23. (canceled)
